(19) United States
(12) Patent Application Publication
(10) Pub. No.: US 2011/0187687 A1
(43) Pub. Date: Aug. 4, 2011

(54) DISPLAY APPARATUS, DISPLAY METHOD, PROGRAM, AND STORAGE MEDIUM

(76) Inventors: Kouji Saitou, Osaka (JP); Akizumi Fujioka, Osaka (JP)

(21) Appl. No.: 13/122,700

(22) PCT Filed: Oct. 6, 2009
(86) PCT No.: PCT/JP2009/067431

§ 371 Date: Apr. 5, 2011

(30) Foreign Application Priority Data
Oct. 7, 2008 (JP) 2008-260837

(51) Int. Cl. G09G 5/10; G09G 3/30; G09G 3/28; G09G 3/36

(52) U.S. Cl. 345/207; 345/102; 345/63; 345/77

(57) ABSTRACT

A display apparatus (10) of the present invention is a display apparatus (10) including a display panel (11) including optical sensors (2); an illuminance detector section (14) for measuring, on the basis of an output from the optical sensor (2), an illuminance in a display area corresponding to the optical sensor (2); and a display luminance correcting section (19) for correcting, on the basis of the illuminances measured by the illuminance detector section (14), a display luminance in at least one of the display areas. The arrangement allows the display apparatus (10) to correct a luminance of a display image most appropriately for a user.

### TECHNICAL FIELD

The present invention relates to a display apparatus that includes a display panel including optical sensors, a display method, a program, and a storage medium.

### BACKGROUND ART

In environments such as outdoors, a display panel of a display apparatus is irradiated with outside light. This can deteriorate viewability of a displayed image. This is because in a case where a user views that display area on the display panel which is irradiated with the outside light, the outside light reflected on the display panel enters the eyes of the user, as is the case with light emitted from a backlight etc. which are originally provided in the display apparatus. The irradiation of the outside light changes that relative luminance ratio (contrast ratio) between adjacent gradation levels which is originally employed by the display apparatus. As a result, the user cannot distinguish gradation levels.

Patent Literature 1 proposes an art for remedying the problem. Specifically, the art of Patent Literature 1 corresponds to a liquid crystal display apparatus which has: a detector section for measuring a luminance of outside light; and a voltage setting section for setting a pixel voltage for each of input gradation levels in accordance with the luminance measured by the detector section. In the liquid crystal display apparatus, one illuminance sensor is provided outside an active area. With the arrangement, the liquid crystal display apparatus of Patent Literature 1 changes pixel voltages of the whole active area in accordance with an illuminance measured by the illuminance sensor. This makes it possible to display an image with a predetermined image quality, regardless of use environments.

### CITATION LIST

Patent Literature 1
Japanese Patent Application Publication, Tokukai, No. 2008-040488 A (Publication Date: Feb. 21, 2008)

### SUMMARY OF INVENTION

### Technical Problem

However, according to the art of the Patent Literature 1, luminances on the display screen are corrected in a single uniform way. Therefore, in a case where only a part of the display screen is irradiated with the outside light, there arises a display area where its luminance is not appropriately corrected. This causes variation among gamma characteristics of a display image on the display screen. As a result, the display image does not look fine.

The present invention was made to solve the problem. An object of the present invention is to provide: a display apparatus; a display method, a program, and a storage medium each of which effectively improve viewability of a display image on a display panel.

### Solution to Problem

### Display Apparatus

In order to attain the object, a display apparatus of the present invention includes: a display panel including optical sensors; an illuminance detector section for measuring, on the basis of an output from an optical sensor, an illuminance in a display area corresponding to the optical sensor; and a display luminance correcting section for correcting, on the basis of the illuminances measured by the illuminance detector section, a display luminance in at least one of the display areas.

According to the arrangement, the display apparatus includes a display panel including optical sensors. The display panel is, e.g., a liquid crystal panel or an organic EL panel.

On the basis of an output from an optical sensor, the display apparatus measures an illuminance in a display area corresponding to the optical sensor. The display areas which correspond respectively to the optical sensors are those display areas under which corresponding optical sensors receive irradiation light, among those display areas on the screen of the display panel on which an image is displayed. The optical sensors may be provided, e.g., pixel by pixel, or so as to each correspond to a plurality of pixels, within or outside the pixels.

This allows the display apparatus to measure, for every display area, an illuminance of light with which the display panel is irradiated. In other words, it is possible to locally detect the irradiation light incident on the display panel. Then, on the basis of the illuminances measured by the illuminance detector section, the display apparatus corrects a display luminance in at least one of the display areas. Thus, the display apparatus corrects a display luminance in at least one of the display areas, on the basis of the detected local illuminances.

The display apparatus thus locally corrects a display luminance on the display panel. Therefore, even if a part of the display panel is intensively irradiated with outside light, the display apparatus can reduce a difference in look of images between a display area with a higher illuminance and a display area with a lower illuminance. This makes it possible to effectively improve viewability of an image displayed on the display panel.

(Display Method)

In order to attain the object, a display method of the present invention is a display method which is performed by a display apparatus having a display panel which includes optical sensors, the display method including the steps of: measuring, on the basis of an output from an optical sensor, an illuminance in a display area corresponding to the optical sensor; and correcting, on the basis of the illuminances measured in the step of measuring, a display luminance in at least one of the display areas.

The arrangement brings about the same working and the same effect.

For a fuller understanding of the nature and advantages of the invention, reference should be made to the ensuing detailed description taken in conjunction with the accompanying drawings.

### Advantageous Effects of Invention

As described above, the display apparatus of the present invention locally measures illuminances on the display panel so as to correct a display luminance of a display image on the basis of the detected illuminances. This makes it possible to correct a display luminance in accordance with local illuminances on the display panel, so that the display luminance is the best for a user. This makes it possible to effectively improve viewability of a display image.

### BRIEF DESCRIPTION OF DRAWINGS

FIG. 1 is a block diagram illustrating an arrangement of a main part of a display apparatus of the present invention.

FIG. 2 is a block diagram illustrating, in detail, an arrangement of a liquid crystal panel of the display apparatus illustrated in FIG. 1.

FIG. 3 is a schematic view illustrating those display areas on the liquid crystal panel of the display apparatus illustrated in FIG. 1 which are irradiated with outside light at respective different irradiation amounts.

FIG. 4 is a view illustrating one example of an illuminance distribution on the screen of the liquid crystal panel illustrated in FIG. 1.

FIG. 5 is a graph showing respective gamma characteristics of two display areas illustrated in FIG. 4 which are different in illuminance.

FIG. 6 is an enlarged view of a cross-sectional view of that part of the liquid crystal panel which partially covers the two display areas illustrated in FIG. 3 which are irradiated with outside light at respective different irradiation amounts.

FIG. 7 is a view illustrating one example of an illuminance distribution on the screen of the liquid crystal panel illustrated in FIG. 1.

FIG. 8 is a graph showing respective gamma characteristics in those two display areas illustrated in FIG. 7 which are different in illuminance.

FIG. 9 is a view illustrating one example of an illuminance distribution on the screen of the liquid crystal panel illustrated in FIG. 1.

FIG. 10 is a graph showing respective gamma characteristics in those two display areas illustrated in FIG. 9 which are different in illuminance.

FIG. 11 is a view illustrating one example of an illuminance distribution on the screen of the liquid crystal panel illustrated in FIG. 1.

FIG. 12 is a graph showing respective gamma characteristics in those three display areas illustrated in FIG. 11 which are different in illuminance.

FIG. 13 is a view illustrating one example of an illuminance distribution in that priority area on the liquid crystal panel illustrated in FIG. 1 in which a higher viewability is secured.

FIG. 14 is a graph showing respective gamma characteristics in those two display areas illustrated in FIG. 13 which are different in illuminance.

FIG. 15 is a view illustrating one example of an illuminance distribution in that priority area on the liquid crystal panel illustrated in FIG. 1 in which a higher viewability is secured.

FIG. 16 is a graph showing respective gamma characteristics in those two display areas illustrated in FIG. 15 which are different in illuminance.

FIG. 17 is a view illustrating one example of an illuminance distribution on a screen of an organic EL panel.

FIG. 18 is a graph showing respective gamma characteristics in those two display areas illustrated in FIG. 17 which are different in illuminance.

### DESCRIPTION OF EMBODIMENTS

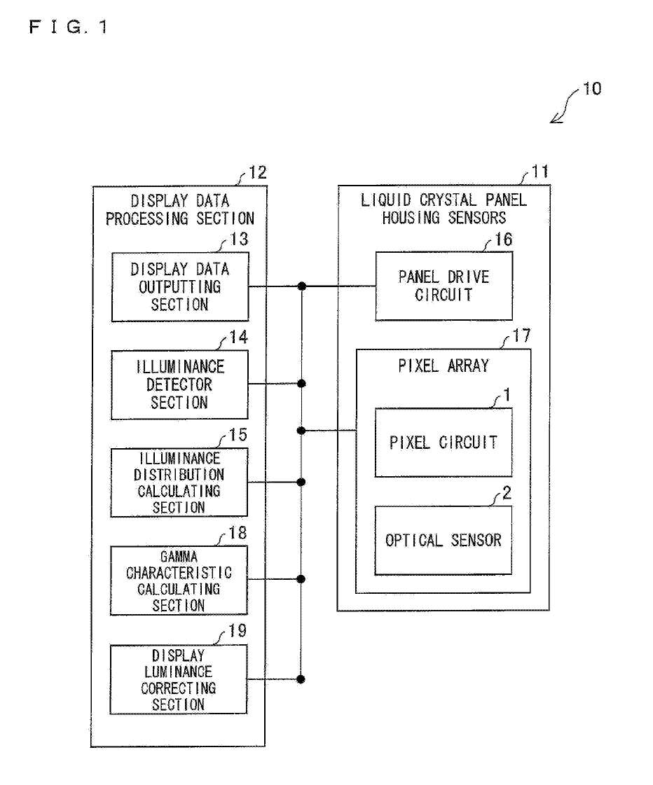

The following describes one embodiment of a display apparatus of the present invention, with reference to FIGS. 1 to 12.

(Arrangement of Display Apparatus 10)

The following first describes an arrangement of a display apparatus 10 of the present invention, with reference to FIG. 1.

FIG. 1 is a block diagram illustrating an arrangement of a main part of the display apparatus 10. As illustrated in FIG. 1, the display apparatus 10 includes a display data processing section 12 and a liquid crystal panel 11 (display panel) with built-in sensors. The display data processing section 12 includes a display data outputting section 13, an illuminance detector section 14 (illuminance detecting section), an illuminance distribution calculating section 15, a gamma characteristic calculating section 18, and a display luminance correcting section 19.

The liquid crystal panel 11 with built-in sensors (hereinafter, referred to as liquid crystal panel 11) includes a panel drive circuit 16 and a pixel array 17. The pixel array 17 includes a plurality of pixel circuits 1 which are two-dimensionally arranged, and a plurality of optical sensors 2.

The display data outputting section 13 supplies display data to the panel drive circuit 16. In accordance with the display data, the panel drive circuit 16 supplies voltages to the pixel circuits 1 of the liquid crystal panel 11. Thus, an image is displayed on the liquid crystal panel 11 in accordance with the display data.

In addition to the supply of the voltages to the pixel circuits 1, the panel drive circuit 16 receives voltages from the optical sensors 2 in accordance with amounts of light received by the optical sensors 2. Output signals from the optical sensors 2 are outputted to the outside of the liquid crystal panel 11 as sensor output signals. Before the sensor output signals are outputted to the outside of the liquid crystal panel 11, an A/D converter (not illustrated) converts the sensor output signals which are analog signals into digital signals. Detailed processing of each of the members is described later.

(Arrangement of Liquid Crystal Panel 11)

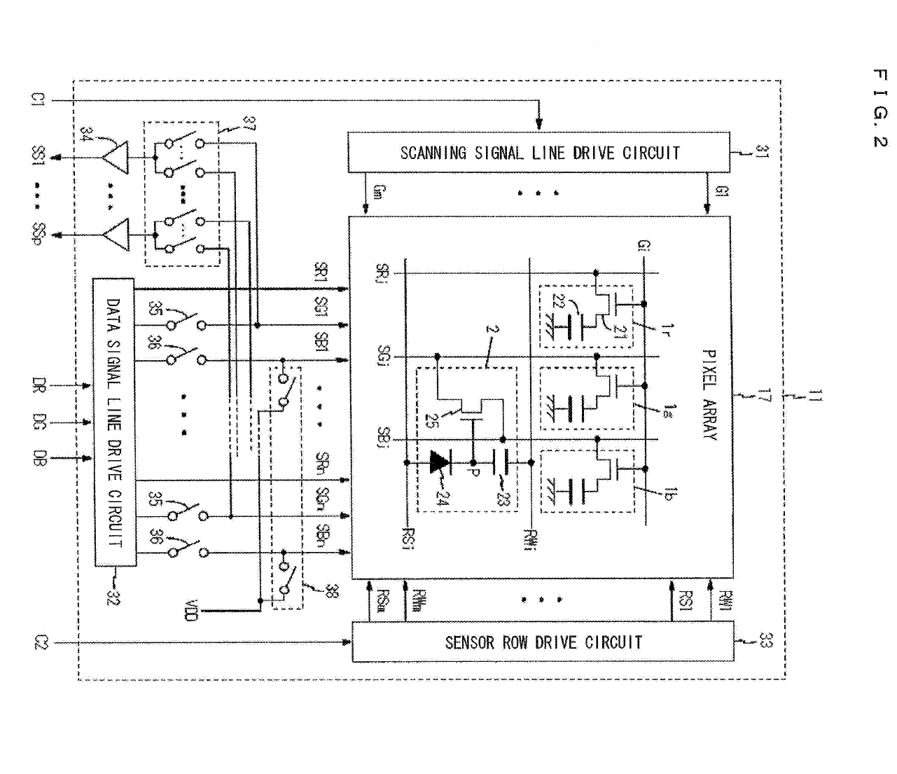

FIG. 2 is a block diagram illustrating a detailed arrangement of the liquid crystal panel 11. As illustrated in FIG. 2, the pixel array 17 includes: “m” number of scanning signal lines G1 through Gm; 3n number of data signal lines SR1 through SRn, SG1 through SGn, and SB1 through SBn; and (m×3n) number of pixel circuits 1. In addition to this, the pixel array 17 includes (m×n) optical sensors 2, “m” number of sensor readout lines RW1 through RWm, and “m” number of sensor reset lines RS1 through RSm. The liquid crystal panel 11 is made from polycrystalline silicon.

The scanning signal lines G1 through Gm are provided so as to be parallel with each other. The data signal lines SR1 through SRn, SG1 through SGn, and SB1 through SBn are provided so as to be parallel with each other and so as to orthogonally intersect with the scanning signal lines G1 through Gm. The sensor readout lines RW1 through RWm and the sensor reset lines RS1 through RSm are provided so as to be parallel with the scanning signal lines G1 through Gm.

Each of the pixel circuits 1 is provided in the vicinity of an intersection of a corresponding one of the scanning signal lines G1 through Gm and a corresponding one of the data signal lines SR1 through SRn, SG1 through SGn, and SB1 through SBn. “m” number of the pixel circuits 1 are arranged in the column direction (i.e., vertical direction in FIGS. 2), and 3n number of the pixel circuits 1 are arranged in the row direction (i.e., horizontal direction in FIG. 2). The pixel circuits 1 are thus two-dimensionally arranged as a whole. The pixel circuits 1 are classified into R pixel circuits 1r, G pixel circuits 1g, and B pixel circuits 1b, by a color of a color filter provided to each of the pixel circuits 1. The three types of pixel circuits 1 are arranged in the row direction in order of R, G, and B, and a combination of the three pixel circuits 1 corresponds to one pixel.

Each of the pixel circuits 1 includes a TFT (Thin Film Transistor) 21 and a liquid crystal capacitor 22. A gate terminal of the TFT 21 is connected with a corresponding one of the scanning signal lines Gi (i is an integer of not less than 1 but not more than “m”). On the other hand, a source terminal of the TFT 21 is connected with corresponding one of the data signal lines SRj, SGj, and SBj (j is an integer of not less than 1 but not more than “n”). A drain terminal of the TFT 21 is connected with one of two electrodes of a corresponding liquid crystal capacitor 22. A common electrode voltage is applied to the other one of the two electrodes of the liquid crystal capacitor 22. Hereinafter, the data signal lines SG1 to SGn connected with the G pixel circuits 1g are referred to as G data signal lines. Similarly, the data signal lines SB1 to SBn connected with the B pixel circuits 1b are referred to as B data signal lines. Each of the pixel circuits 1 may have a storage capacitor.

An optical transmittance (i.e., luminance of a subpixel) of each of the pixel circuits 1 is determined by a voltage supplied thereto. In order to supply a pixel voltage to a pixel circuit 1 connected with a scanning signal line Gi and with a data signal line SXj (X is R, G, or B), a high level voltage (i.e., voltage which turns on a corresponding TFT 21) is applied to the scanning signal line Gi, and the pixel voltage is applied to the data signal line SXj. By supplying the pixel voltage to the pixel circuit 1 in accordance with display data D2, it becomes possible to set a luminance of a subpixel to a desired level.

(Arrangement of Optical Sensor 2)

Each of the optical sensors 2 includes a capacitor 23, a photodiode 24, and a sensor preamplifier 25. The optical sensors 2 are provided to the pixels, respectively. One of two electrodes of the capacitor 23 is connected with a cathode terminal of a corresponding photodiode 24 (hereinafter, this connection point is referred to as a node point P). The other one of the two electrodes of the capacitor 23 is connected with a corresponding sensor readout line RWi. An anode terminal of the photodiode 24 is connected with a corresponding sensor reset line RSi. The sensor preamplifier 25 is a TFT such that: a gate terminal thereof is connected with the node point P; a drain terminal thereof is connected with the B data signal line SBj; and a source terminal thereof is connected with the G data signal line SGj.

In order that an amount of light is measured by an optical sensor 2 which is connected with the sensor readout line RWi, the B data signal line SBj, etc., a predetermined voltage is applied to the sensor readout line RWi and the sensor reset line RSi, and a source voltage VDD is applied to the B data signal line SBj. In a case where light is incident on the photodiode 24 after the predetermined voltage is applied to the sensor readout line RWi and the sensor reset line RSi, a current according to an amount of the incident light flows through the photodiode 24 so that a voltage at the node point P decreases in accordance with the current. Simultaneously, a high voltage is applied to the sensor readout line RWi so as to increase a voltage at the node point P, and a gate voltage of the sensor preamplifier 25 is set to or higher than a threshold. Then, the source voltage VDD is applied to the B data signal line SBj. Accordingly, the voltage at the node point P is amplified by the sensor preamplifier 25. As a result, the amplified voltage is outputted to the G data signal line SGj. Thus, it is possible to know an amount of light measured by the optical sensor 2, on the basis of the voltage of the G data signal line SGj.

Provided in the vicinity of the pixel array 17 are scanning signal line drive circuit 31, a data signal line drive circuit 32, a sensor row drive circuit 33, “p” (p is an integer of not less than 1 but not more than “n”) number of sensor output amplifiers 34, and a plurality of switches 35 to 38. The scanning signal line drive circuit 31, the data signal line drive circuit 32, and the sensor row drive circuit 33 correspond to the panel drive circuit 16 in FIG. 1.

The data signal line drive circuit 32 has 3n number of output terminals which correspond respectively to the 3n number of data signal lines. Each of the switches 35 is provided between a corresponding one of the G data signal lines SG1 through SGn and a corresponding one of “n” number of output terminals. Each of the switches 36 is provided between a corresponding one of the B data signal lines SB1 through SBn and a corresponding one of “n” number of output terminals. The G data signal lines SG1 through SGn are divided into groups each containing “p” number of G data signal lines. Each of the switches 37 is provided between a k-th G data signal line (k is an integer of not less than 1 but not more than “p”) in each of the groups and a k-th input terminal of a corresponding sensor output amplifier 34. The B data signal lines SB1 through SBn are connected with terminals of the switch 38 on one side with respect to the switch 38, respectively. The supply voltage VDD is applied to a terminal of the switch 38 on the other side. FIG. 2 illustrates “n” number of switches 35, “n” number of switches 36, “n” number of switches 37, and one switch 38.

The display apparatus 10 divides one frame period into a display period in which signals (voltage signals corresponding to display data) are supplied to the pixel circuits 1, and a sensing period in which signals (voltage signals corresponding to amounts of light received by the optical sensors 2) are read out from the optical sensors 2. Accordingly, the circuits illustrated in FIG. 2 operate differently in the display period from in the sensing period. In the display period, the switches 35 and 36 are in an ON state whereas the switches 37 and 38 are in an OFF state. In the sensing period, the switches 35 and 36 are in the OFF state whereas the switch 38 is in the ON state. The switches 37 enter the ON state in a time division manner so that the G data signal lines SG1 through SGn are electrically connected, sequentially group by group, with input terminals of a corresponding sensor output amplifier 34.

In the display period, the scanning signal line drive circuit 31 and the data signal line drive circuit 32 operate. In accordance with a timing control signal C1, the scanning signal line drive circuit 31 selects, in every one line period, one of the scanning signal lines G1 through Gm so as to apply a high level voltage to the selected scanning signal line and apply a low level voltage to the other scanning signal lines. In accordance with display data items DR, DG, and DB which are supplied from the display data processing section 12, the data signal line drive circuit 32 drives the data signal lines SR1 through SRn, SG1 through SGn, and SB1 through SBn, by line sequential driving. More specifically, the data signal line drive circuit 32 stores at least display data items DR, DG, and DB each of which corresponds to one line, so as to apply, in every one line period, voltages corresponding to the display data indicative of the one line to the data signal lines SR1 through SRn, SG1 through SGn, and SB1 through SBn. The data signal line drive circuit 32 may drive the data signal lines SR1 through SRn, SG1 through SGn, and SB1 through SBn by dot sequential driving.

In the sensing period, the sensor row drive circuit 33 and the sensor output amplifiers 34 operate. In accordance with a timing control signal C2, the sensor row drive circuit 33 selects, in one line period, one of the sensor readout lines RW1 through RWm and one of the sensor reset lines RS1 through RSm, so as to apply a predetermined readout voltage and a predetermined reset voltage respectively to the selected sensor readout line and the selected sensor reset line, and apply, to other sensor readout lines and other sensor reset lines, voltages which are different from the predetermined readout voltage and the predetermined reset voltage. The one line period typically varies between the display period and the sensing period. The sensor output amplifiers 34 amplifies voltages selected by the switches 37 so as to output as sensor output signals SS1 through SSp.

(Details of Processing by Display Apparatus 10)

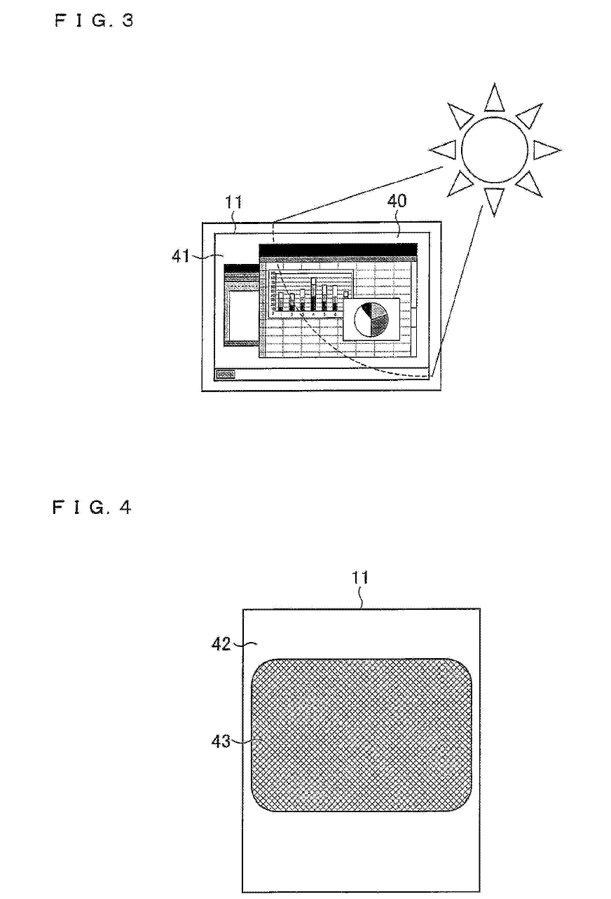

The display apparatus 10 of the present embodiment calculates illuminances in display areas on the liquid crystal panel 11, on the basis of outputs of the optical sensors 2. Then, on the basis of the calculated illuminances, the display apparatus 10 corrects an aperture ratio with respect to light from a backlight layer (backlight) 67, thereby individually correcting display luminances in the display areas. The following describes this by describing details of processing that the display apparatus 10 carries out, with reference to FIGS. 3 to 6.

FIG. 3 is a schematic view illustrating those display areas on the liquid crystal panel 11 which are irradiated with outside light at respective different irradiation amounts. As illustrated in FIG. 3, a screen of the liquid crystal panel 11 is irradiated with outside light (sunlight). In the display apparatus 10, first, the optical sensors 2 detect light with which the screen is irradiated. Then, the optical sensor 2 supplies signals indicative of amounts of the light to the illuminance detector section 14.

FIG. 3 illustrates, on both sides of a dashed line, a display area 40 on which the sunlight is incident, and a display area 41 on which the sunlight is not incident. In this case, the display area 40 is irradiated with a larger amount of the outside light than that of the display area 41. Therefore, an illuminance measured in the display area 40 is higher than that of display area 41.

The illuminance detector section 14 determines illuminances in the display areas 40 and 41 on the liquid crystal panel 11, on the basis of the signals supplied from the optical sensors 2. Then, the illuminance detector section 14 supplies data indicative of the determined illuminances to the illuminance distribution calculating section 15. On the basis of the data, the illuminance distribution calculating section 15 calculates an illuminance distribution on the liquid crystal panel 11.

(Illuminance Distribution)

The following describes one example of an illuminance distribution on the screen of the liquid crystal panel 11, with reference to FIG. 4. FIG. 4 is a view illustrating the one example of an illuminance distribution on the screen of the liquid crystal panel 11. As described with reference to FIG. 3, the liquid crystal panel 11 is not always uniformly irradiated with light. This can lead to an illuminance distribution illustrated in FIG. 4 within the screen of the liquid crystal panel 11. The illuminance distribution illustrated in FIG. 4 is merely an explanatory example. Further, the illuminance distribution does not directly correspond to the display area 40 in FIG. 3 on which the sunlight is incident. FIG. 3 is a schematic view illustrating those display areas which are irradiated with outside light at respective different irradiation amounts. FIG. 4 is a view illustrating one example of an illuminance distribution on the liquid crystal panel 11.

As illustrated in FIG. 4, a display area 43 locates in a central area on the liquid crystal panel 11. The rest is a display area 42. In the display area 43, an illuminance is higher than in the display area 42 since outside light such as sunlight is incident on the display area 43, as described with reference to, e.g., FIG. 3. In contrast, the display area 42 is not irradiated with the outside light such as the sunlight, but irradiated with light from a fluorescent lamp or the like provided, e.g., on a ceiling of a room. Accordingly, an illuminance in the display area 42 is lower than in the display area 43.

Specifically, the illuminance distribution calculating section 15 of the present embodiment calculates an illuminance distribution such as the one illustrated in FIG. 4. Then, the illuminance distribution calculating section 15 supplies data indicative of the calculated illuminance distribution to the gamma characteristic calculating section 18.

First, the gamma characteristic calculating section 18 determines a plurality of display areas with respective different illuminances, on the basis of the supplied data indicative of the illuminance distribution. These display areas correspond to the illuminance distribution illustrated in FIG. 4. The gamma characteristic calculating section 18 calculates respective gamma characteristics of the display areas.

(Gamma Characteristic)

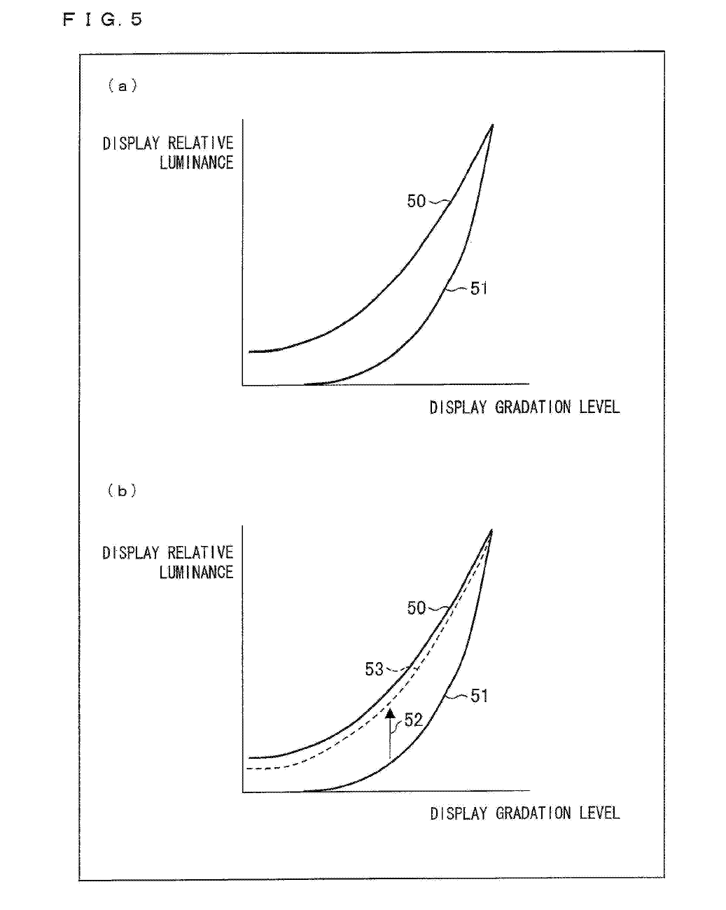

The liquid crystal panel 11 has different gamma characteristics among display areas with respective different illuminances. The following describes the different gamma characteristics, with reference to FIG. 5. (a) of FIG. 5 is a graph showing respective gamma characteristics in those two display areas illustrated in FIG. 4 which are different in illuminance. (b) of FIG. 5 is a graph showing how a display luminance is corrected on the basis of the gamma characteristics. The correction of a display luminance is described later in detail.

A gamma characteristic is a characteristic which indicates a relationship between (i) an original gradation level of an image to be displayed on the screen of the liquid crystal panel 11 and (ii) a luminance (relative luminance) at the reproduction of the image. In FIG. 5, the horizontal axis represents the former (i.e., display gradation levels) and the vertical axis represents the latter (i.e., display relative luminances). A characteristic 50 in FIG. 5 represents the gamma characteristic of the display area 43 in FIG. 4. In other words, the characteristic 50 is that of the display area with the higher illuminance. On the other hand, a characteristic 51 in FIG. 5 represents the gamma characteristic of the display area 42 in FIG. 4. In other words, the characteristic 51 is that of the display area with the lower illuminance.

A user can comfortably view the screen of the liquid crystal panel 11 in a case where gamma characteristics are identical among the display areas on the liquid crystal panel 11, i.e., in a case where characteristics (such as amounts of light) of the outside light are identical among the display areas with which outside light the whole screen of the liquid crystal panel 11 is irradiated. In contrast, in a case where, as described above, two display areas which constitute one screen have respective different gamma characteristics, it follows that a user views, on the screen, two image areas displayed according to the two different gamma characteristics. As a result, viewability is remarkably impaired.

(Correction of Display Luminance)

In view of this, the display apparatus 10 of the present embodiment corrects a display luminance so as to approximate a plurality of gamma characteristics as possible. Specifically, the gamma characteristic calculating section 18 calculates respective gamma characteristics (the characteristics 50 and 51 in the present case) of the display areas so as to supply the data indicative of the calculated gamma characteristics to the display luminance correcting section 19. The display luminance correcting section 19 corrects a display luminance on the screen of the liquid crystal panel 11, on the basis of the supplied gamma characteristics.

The display luminance correcting section 19 corrects a display luminance on the basis of an size of a display area with respect to a size of the whole liquid crystal panel 11. According to FIG. 4, the display area 43 with the higher illuminance locates in the central area on the screen, and occupies, on the liquid crystal panel 11, a larger area than the display area 42 with the lower illuminance. In this case, the display luminance correcting section 19 accordingly corrects a display luminance on the basis of the characteristic 50 of the display area 43 with the higher illuminance.

Specifically, as shown in (b) of FIG. 5, the display luminance correcting section 19 corrects a display luminance so as to approximate the characteristic 51 of the display area 42 to the characteristic 50 of the display area 43. That is, the display luminance correcting section 19 corrects the display luminance by moving a curve of the characteristic 51 in a direction indicated with an arrow 52 so that the characteristic 51 becomes a characteristic represented by a curve indicated with a dashed line 53. Preferably, the display luminance correcting section 19 corrects the display luminance so that the characteristics 51 and 50 become identical with each other. If it is impossible to correct the display luminance so that the characteristics 51 and 50 become completely identical with each other, the display luminance is corrected so that the characteristics 51 and 50 become very close to each other. This makes it possible to display a homogeneous image on the whole liquid crystal panel 11. As a result, a user can view an image without deterioration of its display quality. How a display luminance is actually corrected is described later.

In the present embodiment, the display luminance correcting section 19 corrects the display luminance so as to move the curve of the characteristic 51 to a position directly below the curve of the characteristic 50. However, a correction amount is not limited to this. Alternatively, the correction amount may be increased so that the curve of the corrected characteristic 51 is positioned above the curve of the characteristic 50. In other words, the correction amount is not particularly limited, provided that a gamma characteristic is very close to a reference gamma characteristic (in the present embodiment, the characteristic 50).

(Positions of Optical Sensors)

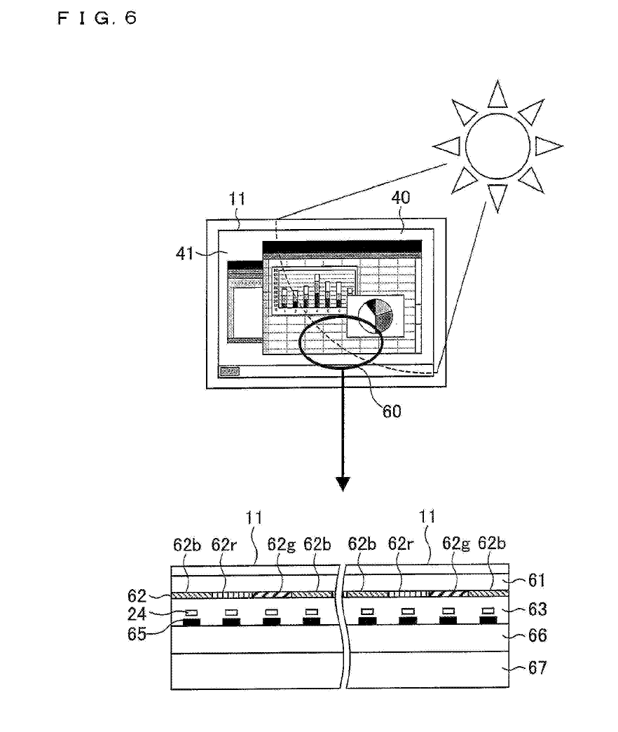

The following describes how the optical sensors 2 are disposed, with reference to FIG. 6. FIG. 6 is an enlarged view of a cross-sectional view of that part of the liquid crystal panel 11 which partially covers the two display areas illustrated in FIG. 3 which are irradiated with outside light at respective different irradiation amounts.

FIG. 6 shows an enlarged view of a cross-section of a part 60 of the liquid crystal panel 11. As illustrated in the lower half of FIG. 6, the liquid crystal panel 11 includes a glass substrate 11, color filters 62, liquid crystal 63, photodiodes 64, light blocking sections 65, a TFT layer 66, and a backlight layer (backlight) 67, in this order from a display surface. Disposed as the color filters 62 are blue color filters 62b, red color filters 62r, and green color filters 62g. The photodiodes 24 are disposed so as to correspond to the color filters 62, respectively.

Thus, according to the present embodiment, the photodiodes 24, in other words, the optical sensors 2 including the photodiodes 24 are disposed so as to correspond to the color filters 62, respectively. That is, the optical sensors 2 are provided pixel by pixel. This makes it possible to correct a display luminance by changing, pixel by pixel, a voltage to be applied to a pixel in each of the two adjacent display areas illustrated in FIG. 6 which are irradiated with outside light at respective different irradiation amounts. This makes it possible to distinguish spectral characteristics so as to apply, color by color, an appropriate voltage to a pixel, even if the liquid crystal panel 11 is irradiated with different types of light such as daylight and light of the setting sun depending on time. This makes it possible to keep a tinge of a display image homogenous.

Positions where the optical sensors 2 are disposed are not limited to those described above. The optical sensors 2 may be disposed by groups each containing a plurality of pixels (e.g., by pixel groups each containing 10×10 pixels), instead of the pixel-by-pixel basis. Furthermore, positions of the optical sensors 2 are not limited to those in the pixels but may be those outside the pixels, provided that the optical sensors 2 are provided inside the liquid crystal panel 11. Positions of the optical sensors 2 are not specified in the present embodiment, provided that it is possible to locally detect light with which the screen of the liquid crystal panel 11 is irradiated.

(Correction on the Basis of a Display Area with a Lower Illuminance)

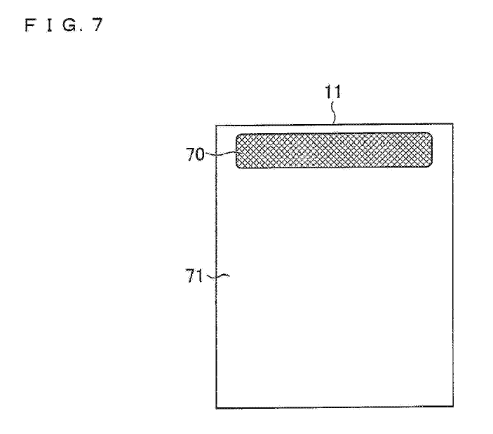

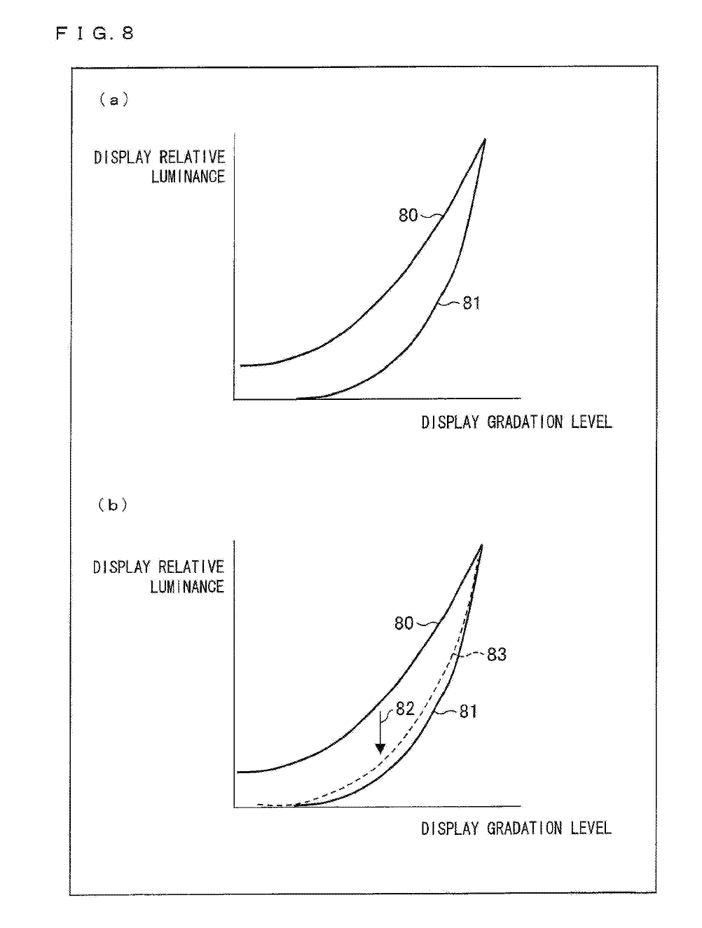

With reference to FIGS. 7 and 8, the following describes an example of correction of a display luminance, which example is different from that described with reference to FIGS. 4 and 5. FIG. 7 is a view illustrating one example of an illuminance distribution on the screen of the liquid crystal panel 11 illustrated in FIG. 1, which one example is different from that of FIG. 4.

As illustrated in FIG. 7, the liquid crystal panel 11 has a display area 70 in its upper area, and has a display area 71 as the rest area. In the display area 70, an illuminance is higher than in the display area 71 since outside light such as sunlight is incident on the display area 70, as described with reference to, e.g., FIG. 3. In contrast, the display area 71 is not irradiated with the outside light such as the sunlight, but irradiated with light from a fluorescent lamp or the like provided, e.g., on a ceiling of a room. Accordingly, an illuminance in the display area 71 is lower than in the display area 70.

(a) of FIG. 8 is a graph showing respective gamma characteristics in those two display areas illustrated in FIG. 7 which are different in illuminance. (b) of FIG. 8 is a graph showing how a display luminance is corrected on the basis of the gamma characteristics. In FIG. 8, the horizontal axis represents display gradation levels and the vertical axis represents display relative luminances. Since gamma characteristic is described above, the following does not repeat the detailed explanations.

A characteristic 80 in FIG. 8 represents the gamma characteristic of the display area 70 in FIG. 7. In other words, the characteristic 80 is that of the display area with the higher illuminance. On the other hand, a characteristic 81 in FIG. 8 represents the gamma characteristic of the display area 71 in FIG. 7. In other words, the characteristic 81 is that of the display area with the lower illuminance.

The display luminance correcting section 19 corrects a display luminance on the basis of a size of a display area with respect to a size of the whole liquid crystal panel 11. According to FIG. 7, the display area 71 with the lower illuminance occupies, on the liquid crystal panel 11, a larger area than the display area 70 with the higher illuminance. In this case, the display luminance correcting section 19 corrects a display luminance on the basis of the characteristic 81 of the display area 71 with the lower illuminance.

Specifically, as shown in (b) of FIG. 8, the display luminance correcting section 19 corrects a display luminance so as to approximate the characteristic 80 of the display area 70 to the characteristic 81 of the display area 71. That is, the display luminance correcting section 19 corrects the display luminance by moving a curve of the characteristic 80 in a direction indicated with an arrow 82 so that the characteristic 80 becomes a characteristic represented by a curve indicated with a dashed line 83. In this correction, the display luminance correcting section 19 preferably corrects the display luminance so that the characteristics 80 and 81 approximate as possible. If it is impossible to correct the display luminance so that the characteristics 80 and 81 become completely identical with each other, the display luminance is corrected so that the characteristics 80 and 81 become very close to each other. As a result, a user can view an image without deterioration of its display quality. Since how a display luminance is actually corrected is described above, the following does not repeat it.

In the correction example, the display luminance correcting section 19 corrects the display luminance so as to move the curve of the characteristic 80 to a position directly above the curve of the characteristic 81. However, a correction amount is not limited to this. Alternatively, the correction amount may be increased so that the curve of the corrected characteristic 80 is positioned below the curve of the characteristic 81. In other words, the correction amount is not particularly limited, provided that a gamma characteristic is very close to a reference gamma characteristic (in the present correction example, the characteristic 81).

(Correction on the Basis of a Display Area with a Higher Illuminance and a Display Area with a Lower Illuminance)

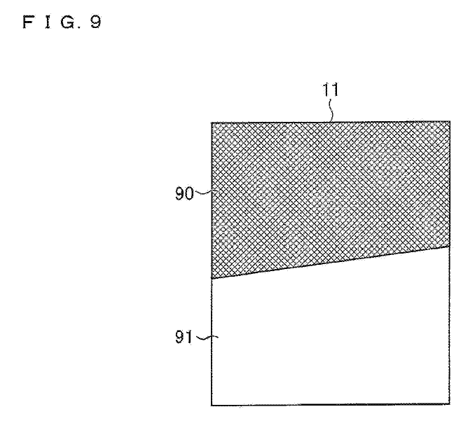

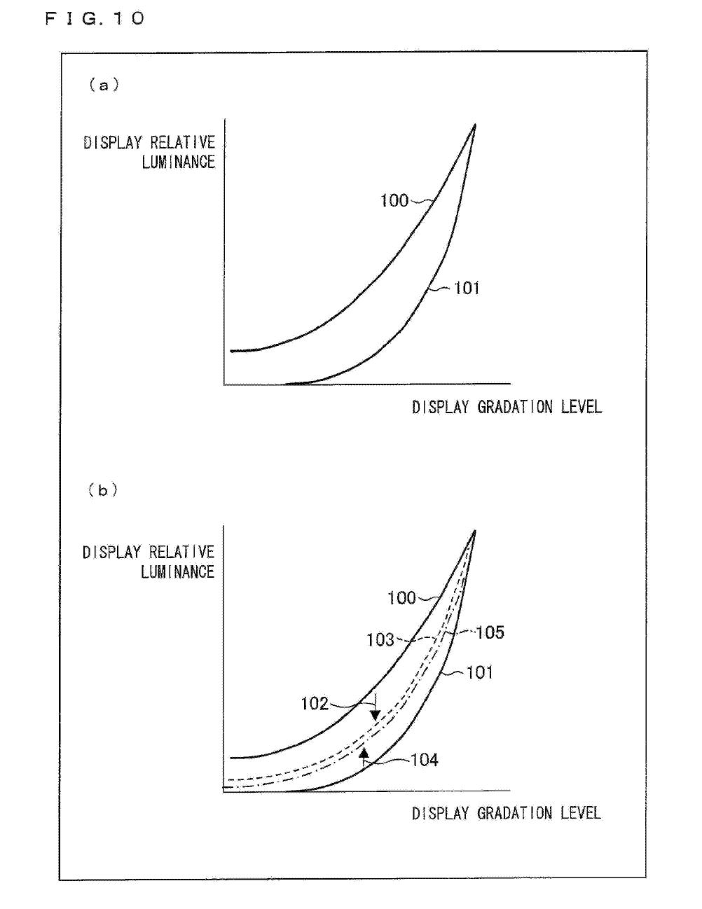

With reference to FIGS. 9 and 10, the following describes still another example of correction of display luminances. FIG. 9 is a view illustrating one example of an illuminance distribution on the screen of the liquid crystal panel 11 illustrated in FIG. 1, which one example is different from those of FIGS. 4 and 7.

In the example of FIG. 9, the display surface of the liquid crystal panel 11 is divided into display areas 90 and 91. The display area 90 has roughly half the area of the display area 91. In the display area 90, an illuminance is higher than in the display area 71 since outside light such as sunlight is incident on the display area 70, as described with reference to, e.g., FIG. 3. In contrast, the display area 91 is not irradiated with the outside light such as the sunlight, but irradiated with light from a fluorescent lamp or the like provided, e.g., on a ceiling of a room. Accordingly, an illuminance in the display area 91 is lower than in the display area 90.

(a) of FIG. 10 is a graph showing respective gamma characteristics in those two display areas illustrated in FIG. 9 which are different in illuminance. (b) of FIG. 10 is a graph showing how a display luminance is corrected on the basis of the gamma characteristics. In FIG. 10, the horizontal axis represents display gradation levels and the vertical axis represents display relative luminances. Since gamma characteristic is described above, the following does not repeat the detailed explanations.

A characteristic 100 in FIG. 10 represents the gamma characteristic of the display area 90 in FIG. 9. In other words, the characteristic 100 is that of the display area with the higher illuminance. On the other hand, a characteristic 101 in FIG. 10 represents the gamma characteristic of the display area 91 in FIG. 9. In other words, the characteristic 101 is that of the display area with the lower illuminance.

The display luminance correcting section 19 corrects a display luminance on the basis of a size of a display area with respect to a size of the whole liquid crystal panel 11. According to FIG. 9, the display area 91 with the lower illuminance and the display area 90 with the higher illuminance both occupy roughly half the area on the liquid crystal panel 11. In this case, therefore, the display luminance correcting section 19 corrects the display luminance on the basis of both the characteristic 100 of the display area 90 with the higher illuminance and the characteristic 101 of the display area 91 with the lower illuminance.

Specifically, as shown in (b) of FIG. 10, the display luminance correcting section 19 corrects both a display luminance of the display area 90 and a display luminance of the display area 91 so as to approximate the characteristics 100 and 101 to each other. First, the display luminance correcting section 19 corrects the display luminance of the display area 90 by moving a curve of the characteristic 100 in a direction indicated with an arrow 102 so that the characteristic 100 becomes a characteristic represented by a curve indicated with a dashed line 102. Furthermore, the display luminance correcting section 19 corrects the display luminance of the display area 91 by moving a curve of the characteristic 101 in a direction indicated with an arrow 104 so that the characteristic 101 becomes a characteristic represented by a curve indicated with a dashed line 105.

Preferably, the display luminance correcting section corrects the display luminances so that the characteristics 100 and 101 approximate as possible. If it is impossible to correct the display luminances so that the characteristics 100 and 101 become completely identical with each other, the display luminances are corrected so that the characteristics 100 and 101 become very close to each other. As a result, a user can view an image without deterioration of its display quality. Since how a display luminance is actually corrected is described above, the following does not repeat it.

In the correction example, the display luminance correcting section 19 corrects the display luminance so as to move the curve of the characteristic 100 to a position directly above the curve of the characteristic 81. However, a correction amount is not limited to this. Alternatively, the correction amount may be increased so that the curve of the corrected characteristic 80 is positioned below the curve of the characteristic 81. In other words, the correction amount is not particularly limited, provided that a gamma characteristic is very close to reference gamma characteristics (in the present correction example, the characteristics 100 and 101).

(Correction on the Basis of a Plurality of Display Areas with Different Illuminances)

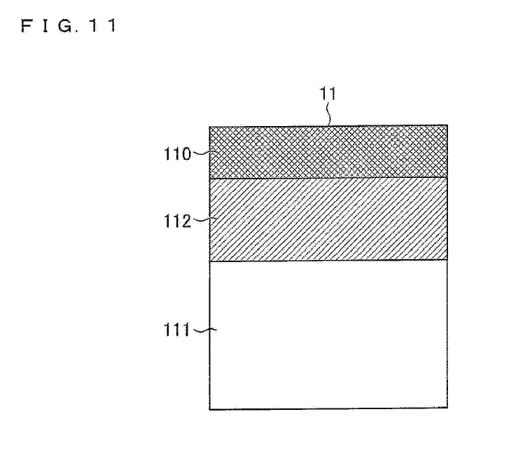

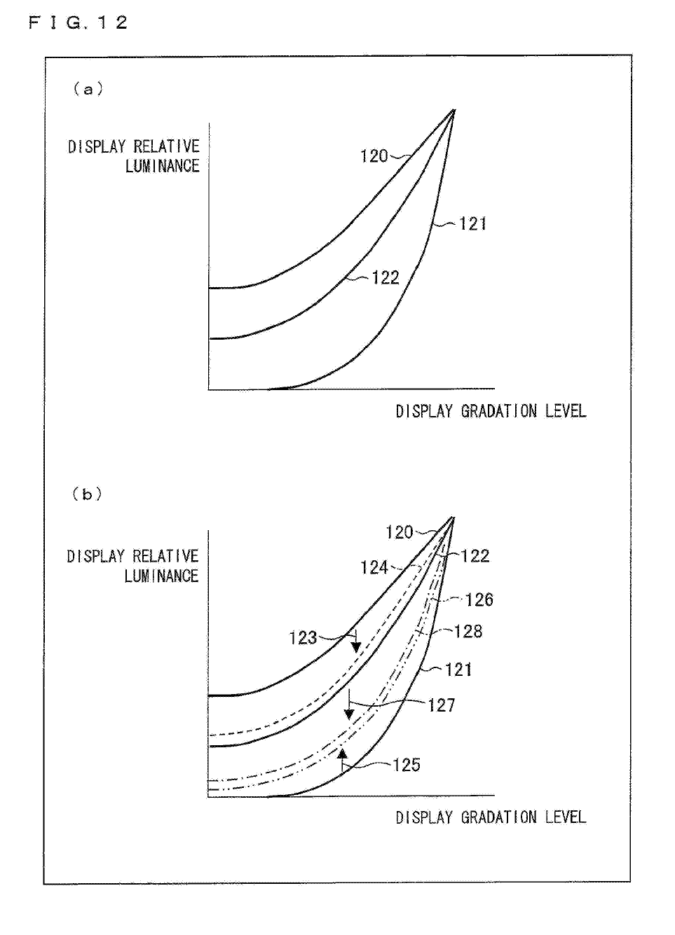

With reference to FIGS. 11 and 12, the following describes yet another example of correction of a display luminance. FIG. 11 is a view illustrating one example of an illuminance distribution on the screen of the liquid crystal panel 11 illustrated in FIG. 1, which one example is different from those of FIGS. 4, 7, and 9.

As illustrated in FIG. 11, the display surface of the liquid crystal panel 11 is divided into display areas 110, 111, and 112. The display areas 110, 111, and 112 have respective different areas. The display area 111 has the largest area. The display area 112 has the second largest area. The display area 110 has the smallest area. In the display area 110, an illuminance is higher than in the display areas 111 and 112 since outside light such as sunlight is incident on the display area 110, as described with reference to, e.g., FIG. 3. In contrast, the display area 111 is not irradiated with the outside light such as the sunlight, but irradiated with light from a fluorescent lamp or the like provided, e.g., on a ceiling of a room. Accordingly, an illuminance in the display area 111 is lower than in the display area 110. In contrast, the display area 112 sandwiched between the display areas 110 and 111 is somewhat irradiated with the outside light such as the sunlight. Therefore, an illuminance in the display area 112 lies between the display areas 110 and 111.

(a) of FIG. 12 is a graph showing respective gamma characteristics in those three display areas illustrated in FIG. 11 which are different in illuminance. (b) of FIG. 12 is a graph showing how a display luminance is corrected on the basis of the gamma characteristics. In FIG. 12, the horizontal axis represents display gradation levels and the vertical axis represents display relative luminances. Since gamma characteristic is described above, the following does not repeat the detailed explanations.

A characteristic 120 in FIG. 12 represents the gamma characteristic of the display area 110 in FIG. 11. In other words, the characteristic 120 is that of the display area with the higher illuminance. On the other hand, a characteristic 101 in FIG. 12 represents the gamma characteristic of the display area 111 in FIG. 11. In other words, the characteristic 101 is that of the display area with the lower illuminance. A characteristic 122 in FIG. 12 represents the gamma characteristic of the display area 112 in FIG. 11. In other words, the characteristic 122 is that of the display area with the illuminance which lies between those of the display areas 110 and 111.

The display luminance correcting section 19 corrects a display luminance on the basis of a size of a display area with respect to a size of the whole liquid crystal panel 11. According to FIG. 11, the display area 111 with the lower illuminance occupies the larger area on the liquid crystal panel 11 than the display area 110 with the higher illuminance and the display area 112 with the intermediate illuminance. However, a sum of the area of the display area 110 with the higher illuminance and the area of the display area 112 with the intermediate illuminance occupies almost half the area of the screen of the liquid crystal display panel 11. In this case, the display luminance correcting section 19 corrects a display luminance mainly on the basis of that display area 111 with the lower illuminance which occupies the largest area on the liquid crystal panel 11. That is, the display luminance correcting section 19 corrects display luminances so as to approximate, to the characteristic 121 of the display area 111 with the lower illuminance, the characteristic 120 of the display area 110 with the higher illuminance and the characteristic 122 of the display area 112 with the intermediate illuminance. Further, the display luminance correcting section 19 corrects a display luminance so as to approximate the characteristic 121 of the display area 111 with the lower illuminance to the characteristic 120 of the display area 110 with the higher illuminance and the characteristic 122 of the display area 112 with the intermediate illuminance.

Specifically, as shown in (b) of FIG. 12, the display luminance correcting section 19 corrects the display luminances so as to approximate the characteristics 120 and 122 to the characteristic 121. That is, the display luminance correcting section 19 corrects a display luminance by moving a curve of the characteristic 120 in a direction indicated with an arrow 123 so that the characteristic 120 becomes a characteristic represented by a curve indicated with a dashed line 124. Then, the display luminance correcting section 19 corrects a display luminance by moving a curve of the characteristic 122 in a direction indicated with an arrow 127 so that the characteristic 122 becomes a characteristic represented by a curve indicated with a dashed line 128. Further, the display luminance correcting section 19 corrects a display luminance by moving a curve of the characteristic 121 in a direction indicated with an arrow 125 so that the characteristic 121 becomes a characteristic represented by a curve indicated with a dashed line 126.

In the correction, it is preferable that the characteristics 120, 121, and 122 approximate as close as possible. If it is impossible to correct the display luminances so that the characteristics 120, 121, and 122 become completely identical with each other, the display luminances are corrected so that the characteristics 120, 121, and 122 become very close to each other. As a result, a user can view an image without deterioration of its display quality. Since how a display luminance is actually corrected is described above, the following does not repeat it.

In the correction example, the display luminance correcting section 19 corrects the display luminances so that the corrected characteristics 124, 128, and 126 are positioned in this order from above. However, a correction amount is not limited to this. In other words, the correction amount is not particularly limited, provided that gamma characteristics are very close to a reference gamma characteristic (in the present correction example, the characteristic 121).

Thus, the display apparatus 10 can measure local illuminances on the liquid crystal panel 11 so as to correct, on the basis of the illuminances, display luminances in display areas so that the display luminances are the best for a user viewing the screen of the liquid crystal panel 11. This makes it possible to effectively improve viewability of a display image.

The above describes the correction of two gamma characteristics and the correction of three gamma characteristics. However, the number of gamma characteristics to be corrected is not limited to them. That is, it is possible to correct display luminances which define as many gamma characteristics as the optical sensors 2 provided in the pixels in a whole display area.

(Example 1 of Correction on the Basis of a Priority Area)

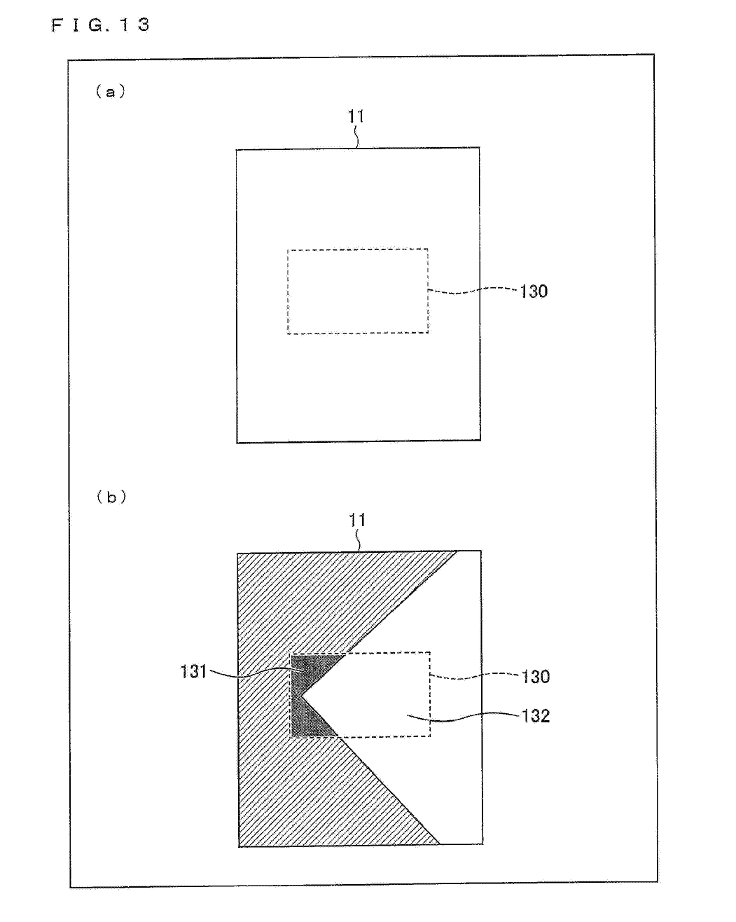

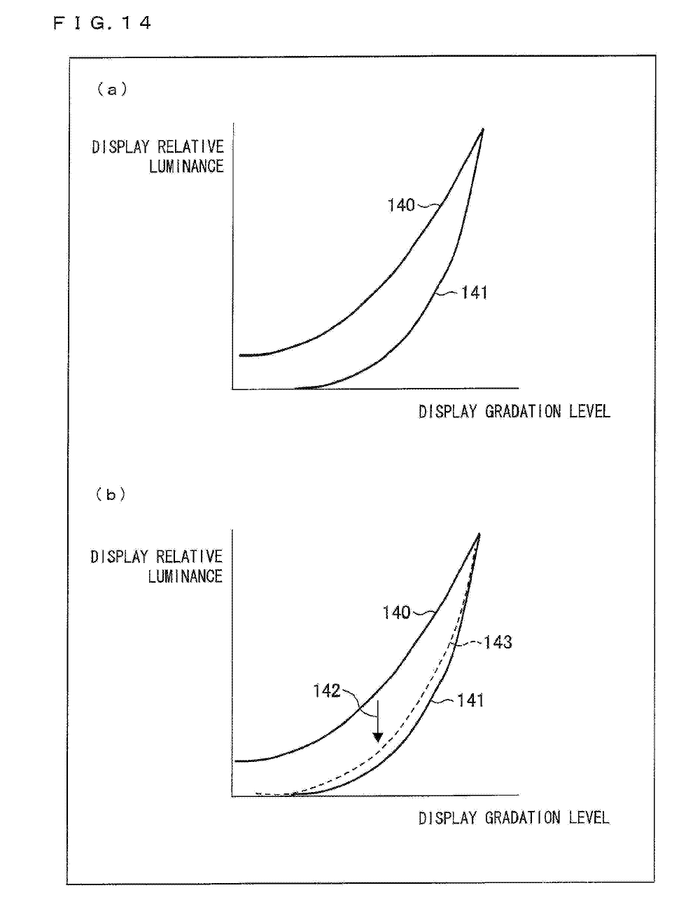

With reference to FIGS. 13 and 14, the following describes still yet another example of correction of display luminances.

FIG. 13 is a view illustrating one example of an illuminance distribution on the screen of the liquid crystal panel 11 illustrated in FIG. 1, which one example is different from those of FIGS. 4, 7, 9, and 11.

As illustrated in (a) of FIG. 13, the liquid crystal panel 11 has a priority area 130. In a display area of the priority area 130, a higher viewability is secured on a priority basis. In the present correction example, a gamma characteristic is corrected on the basis of an illuminance distribution in the priority area 130.

As illustrated in (b) of FIG. 13, the priority area 130 is divided into display areas 131 and 132. In the display area 131, an illuminance is higher than in the display area 132 since outside light such as sunlight is incident on the display area 131, as described with reference to, e.g., FIG. 3. In contrast, the display area 132 is not irradiated with the outside light such as the sunlight, but irradiated with light from a fluorescent lamp or the like provided, e.g., on a ceiling of a room. Accordingly, an illuminance in the display area 132 is lower than in the display area 131.

(a) of FIG. 14 is a graph showing respective gamma characteristics in those two display areas illustrated in FIG. 13 which are different in illuminance. (b) of FIG. 14 is a graph showing how a display luminance is corrected on the basis of the gamma characteristics. In FIG. 14, the horizontal axis represents display gradation levels and the vertical axis represents display relative luminances. Since gamma characteristic is described above, the following does not repeat the detailed explanations.

A characteristic 140 in FIG. 14 represents the gamma characteristic of the display area 131 in FIG. 13. In other words, the characteristic 140 is that of the display area with the higher illuminance. On the other hand, a characteristic 141 in FIG. 14 represents the gamma characteristic of the display area 132 in FIG. 13. In other words, the characteristic 141 is that of the display area with the lower illuminance.

In the present correction example, the display luminance correcting section 19 corrects a display luminance on the basis of a size of a display area with respect to a size of the priority area 130. According to (b) of FIG. 13, the display area 132 with the lower illuminance occupies a larger area in the priority area 130 than the display area 131 with the higher illuminance. In this case, therefore, the display luminance correcting section 19 corrects a display luminance on the basis of the characteristic 141 of the display area 132 with the lower illuminance.

Specifically, as shown in (b) of FIG. 14, the display luminance correcting section 19 corrects the display luminance so as to approximate the characteristic 140 of the display area 131 to the characteristic 141 of the display area 132. That is, the display luminance correcting section 19 corrects the display luminance by moving a curve of the characteristic 140 in a direction indicated with an arrow 142 so that the characteristic 140 becomes a characteristic represented by a curve indicated with a dashed line 143. In this correction, the display luminance correcting section 19 preferably corrects the display luminance so that the characteristics 140 and 141 approximate as close as possible. If it is impossible to correct the display luminance so that the characteristics 140 and 141 become completely identical with each other, the display luminance is corrected so that the characteristics 140 and 141 become very close to each other. As a result, a user can view an image without deterioration of its display quality. Since how a display luminance is actually corrected is described above, the following does not repeat it.

In the present correction example, the display luminance correcting section 19 corrects the display luminance so as to move the curve of the characteristic 140 to a position directly above the curve of the characteristic 141. However, a correction amount is not limited to this. Alternatively, the correction amount may be increased so that the curve of the corrected characteristic 140 is positioned below the curve of the characteristic 141. In other words, the correction amount is not particularly limited, provided that a gamma characteristic is very close to a reference gamma characteristic (in the present correction example, the characteristic 141).

(Example 2 of Correction on the Basis of a Priority Area)

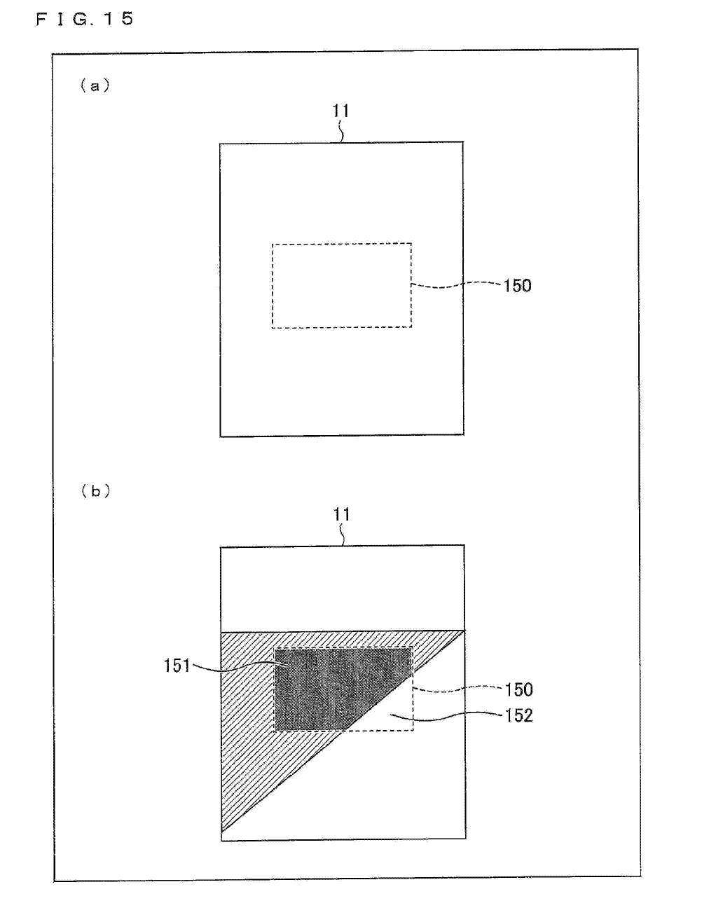

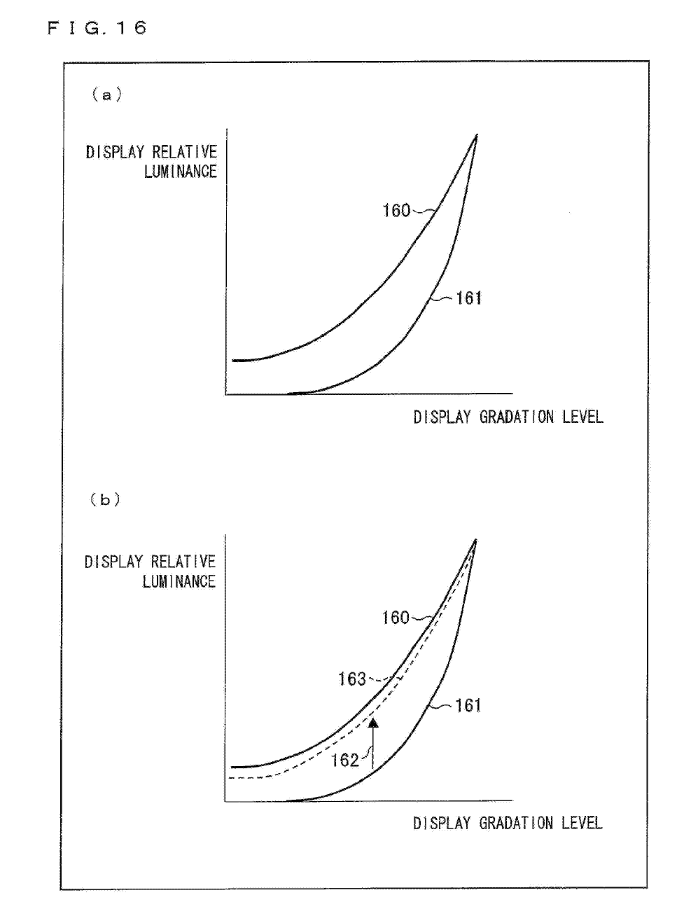

With reference to FIGS. 15 and 16, the following describes still yet another example of correction of a display luminance.

FIG. 15 is a view illustrating one example of an illuminance distribution on the screen of the liquid crystal panel 11 illustrated in FIG. 1, which one example is different from those of FIGS. 4, 7, 9, 11, and 13.

As illustrated in (a) of FIG. 15, the liquid crystal panel 11 has a priority area 150, as is the case with the Example 1. In a display area of the priority area 150, a higher viewability can be secured on a priority basis. Also in the present correction example, a gamma characteristic is corrected on the basis of an illuminance distribution in the priority area 150.

As illustrated in (b) of FIG. 15, the priority area 150 is divided into display areas 151 and 152. In the display area 131, an illuminance is higher than in the display area 132 since outside light such as sunlight is incident on the display area 131, as described with reference to, e.g., FIG. 3. In contrast, the display area 152 is not irradiated with the outside light such as the sunlight, but irradiated with light from a fluorescent lamp or the like provided, e.g., on a ceiling of a room. Accordingly, an illuminance in the display area 152 is lower than in the display area 151.

(a) of FIG. 16 is a graph showing respective gamma characteristics in those two display areas illustrated in FIG. 15 which are different in illuminance. (b) of FIG. 14 is a graph showing how a display luminance is corrected on the basis of the gamma characteristics. In FIG. 16, the horizontal axis represents display gradation levels and the vertical axis represents display relative luminances. Since gamma characteristic is described above, the following does not repeat the detailed explanations.

A characteristic 160 in FIG. 16 represents the gamma characteristic of the display area 151 in FIG. 15. In other words, the characteristic 160 is that of the display area with the higher illuminance. On the other hand, a characteristic 161 in FIG. 16 represents the gamma characteristic of the display area 152 in FIG. 15. In other words, the characteristic 161 is that of the display area with the lower illuminance.

In the present correction example, the display luminance correcting section 19 corrects a display luminance on the basis of a size of a display area with respect to a size of the priority area 150. According to (b) of FIG. 15, the display area 151 with the higher illuminance occupies a larger area in the priority area 150 than the display area 152 with the lower illuminance. In this case, therefore, the display luminance correcting section 19 corrects a display luminance on the basis of the characteristic 160 of the display area 151 with the higher illuminance.

Specifically, as shown in (b) of FIG. 16, the display luminance correcting section 19 corrects the display luminance so as to approximate the characteristic 161 of the display area 152 to the characteristic 160 of the display area 151. That is, the display luminance correcting section 19 corrects the display luminance by moving a curve of the characteristic 161 in a direction indicated with an arrow 162 so that the characteristic 161 becomes a characteristic represented by a curve indicated with a dashed line 163. In this correction, the display luminance correcting section 19 preferably corrects the display luminance so that the characteristics 160 and 161 approximate as close as possible. If it is impossible to correct the display luminance so that the characteristics 160 and 161 become completely identical with each other, the display luminance is corrected so that the characteristics 160 and 161 become very close to each other. As a result, a user can view an image without deterioration of its display quality. Since how a display luminance is actually corrected is described above, the following does not repeat it.

In the present correction example, the display luminance correcting section 19 corrects the display luminance so as to move the curve of the characteristic 162 to a position directly below the curve of the characteristic 160. However, a correction amount is not limited to this. Alternatively, the correction amount may be increased so that the curve of the corrected characteristic 161 is positioned above the curve of the characteristic 160. In other words, the correction amount is not particularly limited, provided that a gamma characteristic is very close to a reference gamma characteristic (in the present correction example, the characteristic 160).

As described in the Examples 1 and 2, a display apparatus of the present invention can appropriately correct display luminances in display areas in a priority area where a specific image is displayed, in accordance with proportions of sizes of the display areas with respect to a size of the priority area. This makes it possible to improve viewability of a specific image on a priority basis.

As illustrated in (a) of FIG. 13 and (a) of FIG. 15, the priority areas 130 and 150 are rectangles. However, shapes thereof are not limited to this. The shape and the number of each of the priority areas 130 and 150 may be varied according to need. In a case where a plurality of priority areas are provided, priorities may be given thereto. Further, an active window (currently-used window on, e.g., a desktop of a PC) may be a priority area.

(Correction of a Display Luminance for an Organic EL Display)

The above describes various examples of correction of a display luminance of a liquid crystal display apparatus. However, the present invention is not limited to this. That is, the present invention is also applicable to self-luminous display apparatuses having various display panels each of which has a plurality of self-luminous display elements, such as organic EL display apparatuses having organic EL panels, and plasma display apparatuses having plasma panels. In this case, according to the present invention, an emission intensity of a display element in a display area of the display panel is corrected so that a display luminance in the display area is corrected.

In the correction examples for the liquid crystal panel 11, a luminance of white color, which is the highest luminance, is not corrected, but only a luminance of a halftone is corrected, so that a gamma characteristic is corrected. This is because a liquid crystal display apparatus is arranged such that a luminance of light emitted from the backlight layer 67 is constant.

On the other hand, an organic EL display apparatus is arranged such that an emission luminance of an EL element is determined in accordance with an electric current passed through the EL element. Therefore, the luminance of white color can be varied in accordance with an illuminance distribution in a display area. That is, an organic EL display apparatus can absolutely correct a display luminance, in contrast to a liquid crystal display apparatus which relatively corrects a display luminance. This makes it possible to widely adjust a correction amount, as compared to the relative correction.

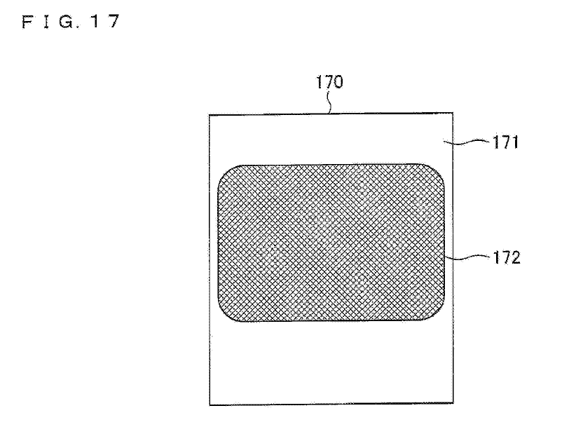

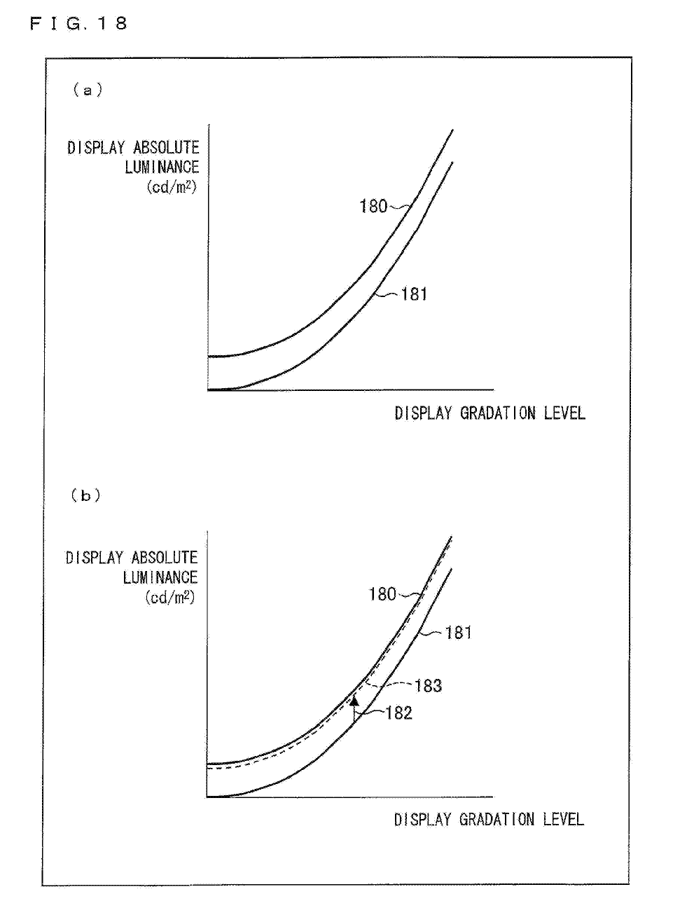

The following describes an example of correction of a display luminance of an organic EL display apparatus, with reference to FIGS. 17 and 18. In the present correction example, the correction is performed on the basis of an illuminance distribution on a screen of an organic EL panel 170, instead of that of the liquid crystal panel 11. FIG. 17 is a view illustrating one example of the illuminance distribution on the organic EL panel 170.

As illustrated in FIG. 17, the organic EL panel 170 has a display area 172 in a central area of the organic EL panel 170, and has a display area 171 as the rest area. In the display area 172, an illuminance is higher than in the display area 171 since outside light such as sunlight is incident on the display area 172, as described with reference to, e.g., FIG. 3. In contrast, the display area 171 is not irradiated with the outside light such as the sunlight, but irradiated with light from a fluorescent lamp or the like provided, e.g., on a ceiling of a room. Accordingly, an illuminance in the display area 171 is lower than in the display area 172.

(a) of FIG. 18 is a graph showing respective luminance characteristics in those two display areas illustrated in FIG. 17 which are different in illuminance. (b) of FIG. 18 is a graph showing how a display luminance is corrected on the basis of the luminance characteristics.

A characteristic 180 in FIG. 18 represents the luminance characteristic of the display area 172 in FIG. 17. In other words, the characteristic 180 is that of the display area with the higher illuminance. On the other hand, a characteristic 181 in FIG. 18 represents the luminance characteristic of the display area 171 in FIG. 17. In other words, the characteristic 181 is that of the display area with the lower illuminance. In FIG. 18, the vertical axis represents absolute values of display luminances.

In the present correction example, the display luminance correcting section 19 corrects a display luminance on the basis of a size of a display area with respect to a size of the whole organic EL panel 170. According to FIG. 17, the display area 172 with the higher illuminance locates in the central area on the screen, and occupies, on the organic EL panel 170, a larger area than the display area 171 with the lower illuminance. In this case, the display luminance correcting section 19 accordingly corrects a display luminance on the basis of the characteristic 180 of the display area 172 with the higher illuminance.

Specifically, as shown in (b) of FIG. 18, the display luminance correcting section 19 corrects a display luminance so as to approximate the characteristic 181 of the display area 171 to the characteristic 180 of the display area 172. That is, the display luminance correcting section 19 corrects the display luminance by moving a curve of the characteristic 181 in a direction indicated with an arrow 182 so that the characteristic 181 becomes a characteristic represented by a curve indicated with a dashed line 183. Preferably, the display luminance correcting section 19 corrects the display luminance so that the characteristics 180 and 181 become identical with each other. If it is impossible to correct the display luminance so that the characteristics 180 and 181 become completely identical with each other, the display luminance is corrected so that the characteristics 180 and 181 become very close to each other.

The present correction example for the organic EL panel 170 describes the correction on the basis of the illuminance distribution illustrated in FIG. 17. However, the display luminance correction of the present invention for the organic EL panel 170 is applicable to various other illuminance distributions. This makes it possible to display a homogeneous image on the whole organic EL panel 170. As a result, a user can view an image without deterioration of its display quality.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

For example, the display apparatus 10 may be arranged such that the optical sensors 2 are provided respectively on back surfaces of the color filters so as to correspond respectively to the pixels each of which has a color of red, green, or blue. This allows the display apparatus 10 to detect, pixel by pixel, outside light with which the liquid crystal panel 11 is irradiated. This makes it possible to correct a display luminance for each of display areas which correspond respectively to the pixels. Accordingly, the display apparatus 10 can correct display luminances most finely. As a result, display quality can be improved maximally.

Further, the display apparatus 10 may be arranged such that each of the optical sensors 2 is provided so as to correspond to a plurality of pixels. The plurality of pixels is, e.g., a group of 10×10 pixels. Accordingly, the display apparatus 10 can detect, by every group, outside light with which the liquid crystal panel 11 is irradiated. Thus, the display apparatus 10 can correct display luminances for display areas which correspond respectively to the groups. Accordingly, the display apparatus 10 can correct display luminances more finely. As a result, display quality can be improved.

(Relative Correction of Display Luminance)

The display apparatus of the present invention preferably includes a backlight for irradiating the display panel with light, and the display luminance correcting section preferably corrects an aperture ratio with respect to the light in the at least one of the display areas so as to correct the display luminance in the at least one of the display areas.

According to the arrangement, the display apparatus is, e.g., a liquid crystal display apparatus. The display apparatus corrects an aperture ratio with respect to the light from the backlight in the at least one of the display areas so as to correct the display luminance in the at least one of the display areas. In other words, the display luminance is relatively corrected.

(Absolute Correction of Display Luminance)

Further, the display apparatus of the present invention is preferably arranged such that: the display panel includes a plurality of self-luminous display elements; and the display luminance correcting section corrects an emission intensity of at least one of the plurality of self-luminous display elements in the at least one of the display areas so as to correct the display luminance in the at least one of the display areas.

According to the arrangement, the display apparatus is, e.g., an organic EL display apparatus. The display apparatus corrects an emission intensity of at least one of the plurality of self-luminous display elements in the at least one of the display areas so as to correct the display luminance in the at least one of the display areas. In other words, the display luminance is absolutely corrected. This makes it possible to adjust a correction amount more widely than the relative correction.

(Correction on the Basis of Illuminance Distribution)

Further, the display apparatus of the present invention preferably further includes: an illuminance distribution calculating section for calculating, on the basis of the illuminances measured by the illuminance detector section, an illuminance distribution on the display panel; and a gamma characteristic calculating section for calculating respective gamma characteristics of the display areas, the gamma characteristic calculating section specifying the display areas on the basis of the illuminance distribution calculated by the illuminance distribution calculating section, the display luminance correcting section correcting the display luminance in the at least one of the display areas on the basis of the gamma characteristics calculated by the gamma characteristic calculating section.

According to the arrangement, the display apparatus calculates, on the basis of the illuminances measured by the illuminance detector section, an illuminance distribution on the display panel. Then, the display apparatus specifies the display areas on the basis of the illuminance distribution calculated by the illuminance distribution calculating section, so as to calculate respective gamma characteristics of the display areas. This makes it possible to calculate respective gamma characteristics of the display areas. Further, the display apparatus corrects the display luminance in the at least one of the display areas on the basis of the gamma characteristics calculated by the gamma characteristic calculating section. This makes it possible to appropriately correct the display luminance, in accordance with respective local luminance characteristics of the display areas.

(Display Luminance Correcting Section)

Further, the display apparatus of the present invention is preferably arranged such that the display luminance correcting section corrects the display luminance on the basis of sizes of the specified display areas with respect to a size of whole of the display panel.

According to the arrangement, the display apparatus corrects the display luminance in the at least one of the display areas on the basis of the sizes of the specified display areas with respect to the size of whole of the display panel. This makes it possible to appropriately correct the display luminance in the at least one of the display areas on the basis of proportions of the sizes of the specified display areas with respect to the size of whole of the display panel. This makes it possible to display a homogeneous image on the whole display panel.

(Priority Area)

Further, the display apparatus of the present invention is preferably arranged such that a priority area is provided within the display panel in advance in which priority area a higher viewability is secured on a priority basis; the specified display areas are areas within the priority area; and the display luminance correcting section corrects the display luminance on the basis of sizes of the specified display areas with respect to a size of the priority area.

According to the arrangement, the display apparatus corrects the display luminance on the basis of the sizes of the specified display areas with respect to the size of that priority area provided within the display panel in advance in which a higher viewability is secured on a priority basis. This makes it possible to appropriately correct, in an area where a specific image is displayed, the display luminance in the at least one of the display areas, in accordance with proportions of the sizes of the specified display areas with respect to the size of the area. This makes it possible to improve viewability of a specific image on a priority basis.

(Display Luminance Correction on the Basis of Display Area with Higher Illuminance)

Further, the display apparatus of the present invention is preferably arranged such that the display luminance correcting section approximates a display luminance of one of the specified display areas which has a lower illuminance to a display luminance of another of the specified display areas which has a higher illuminance.

According to the arrangement, the display apparatus approximates a display luminance of one of the specified display areas which has a lower illuminance to a display luminance of another of the specified display areas which has a higher illuminance. In a case where, e.g., a display area with a higher illuminance occupies a larger area on the display panel, the display apparatus corrects a display luminance of a display area with a lower illuminance so as to approximate the display luminance to that of the display area with the higher illuminance. This allows the display apparatus to correct a local display luminance more appropriately, in accordance with proportions of sizes of the display areas with respect to the size of the whole display panel. This makes it possible to improve viewability of a display image.

(Display Luminance Correction on the Basis of Display Area with Lower Illuminance)

Further, the display apparatus of the present invention is preferably arranged such that the display luminance correcting section approximates a display luminance of one of the specified display areas which has a higher illuminance to a display luminance of another of the specified display areas which has a lower illuminance.

According to the arrangement, the display apparatus approximates a display luminance of one of the specified display areas which has a higher illuminance to a display luminance of another of the specified display areas which has a lower illuminance. In a case where, e.g., a display area with a lower illuminance occupies a larger area on the display panel, the display apparatus corrects a display luminance of a display area with a higher illuminance so as to approximate the display luminance to that of the display area with the lower illuminance. This allows the display apparatus to correct a local display luminance more appropriately, in accordance with proportions of sizes of the display areas with respect to the size of the whole display panel. This makes it possible to improve viewability of a display image.

(Display Luminance Correction on the Basis of Display Area with Higher Illuminance and Display Area with Lower Illuminance)

Further, the display apparatus of the present invention is preferably arranged such that the display luminance correcting section approximates, to each other, a display luminance of one of the specified display areas which has a higher illuminance and a display luminance of another of the specified display areas which has a lower illuminance.

According to the arrangement, the display apparatus approximates, to each other, a display luminance of one of the specified display areas which has a higher illuminance and a display luminance of another of the specified display areas which has a lower illuminance. In a case where, e.g., a display area with a higher illuminance and a display area with a lower illuminance each occupy half the area of the display panel, the display apparatus corrects respective display luminances of the display areas so as to approximate the display luminances to each other. This allows the display apparatus to correct a local display luminance more appropriately, in accordance with proportions of sizes of the display areas with respect to the size of the whole display panel. This makes it possible to improve viewability of a display image.

(Optical Sensors Provided Pixel by Pixel)

Further, the display apparatus of the present invention is preferably arranged such that the optical sensors are provided pixel by pixel.

According to the arrangement, the optical sensors are provided pixel by pixel. For example, the optical sensors are provided respectively on back surfaces of the color filters so as to correspond respectively to the pixels each of which has a color of red, green, or blue. This allows the display apparatus to detect, pixel by pixel, outside light with which the display panel is irradiated. This makes it possible to correct a display luminance for each of display areas which correspond respectively to the pixels. Accordingly, the display apparatus can correct display luminances most finely. As a result, display quality can be improved maximally.

(Optical Sensors Each Provided so as to Correspond to a Plurality of Pixels)

Further, the display apparatus of the present invention is preferably arranged such that each of the optical sensors is provided so as to correspond to a plurality of pixels.

According to the arrangement, each of the optical sensors is provided so as to correspond to the plurality of pixels. The plurality of pixels is, e.g., a group of 10×10 pixels. Accordingly, the display apparatus can detect, by every group, outside light with which the display panel is irradiated. Thus, the display apparatus can correct display luminances for display areas which correspond respectively to the groups. Accordingly, the display apparatus can correct display luminances more finely. As a result, display quality can be improved.

(Program and Storage Medium)

The display apparatus of the present invention may be realized by a computer. In this case, the scope of the present invention encompasses (a) a program that realizes the display apparatus on a computer by causing the computer to operate as respective sections and (b) a computer-readable storage medium in which the program is stored.

(Program and Storage Medium)

Finally, the blocks of the display apparatus 10 may be realized by way of hardware. Otherwise, the blocks may be realized by way of software as executed by a CPU (Central Processing Unit) as follows:

The display apparatus 10 includes a CPU and a memory device (memory medium). The CPU executes instructions in a program realizing the functions. The memory device may be a ROM (Read Only Memory) which contains the program, a RAM (Random Access Memory) to which the program is loaded so as to be in an executable format, and/or a memory containing the program and various data. With the arrangement, the object of the present invention can also be achieved by a predetermined storage medium.

The storage medium stores, in a computer-readable manner, program code (executable program, intermediate code program, or source program) for the display apparatus 10 which program code is software realizing the aforementioned functions. The storage medium is mounted to the display apparatus 10. Accordingly, the display apparatus 10 serving as a computer reads (or, the CPU or an MPU reads) out and executes the program code stored in the mounted storage medium.

A storage medium for supplying the program code to the display apparatus 10 is not limited to one of a specific structure or type. That is, the storage medium may be, for example, a tape, such as a magnetic tape or a cassette tape; a magnetic disk, such as a Floppy® disk or a hard disk, or an optical disk, such as CD-ROM/MO/MD/DVD/CD-R; a card, such as an IC card (incl. memory card) or an optical card; or a semiconductor memory, such as a mask ROM/EPROM/EEPROM/flash ROM.

The object of the present invention can also be achieved by arranging the display apparatus 10 so that the display apparatus 10 may be connectable to a communications network. In this case, the program code is supplied to the display apparatus 10 via the communications network. The communications network is not limited to one of a specific type or form, provided that the program code can be supplied to the display apparatus 10 via the communications network. For example, the communications network may be the Internet, an intranet, extranet, LAN, ISDN, VAN, CATV communications network, virtual dedicated network (Virtual Private Network), telephone line network, mobile communications network, or satellite communications network.

The transfer medium which makes up the communications network is not limited to one of a specific arrangement or type but can be any medium, provided that the program code can be transmitted via the medium. For example, the transfer medium may be wired line, such as IEEE 1394, USB (Universal Serial Bus), electric power line, cable TV line, telephone line, or ADSL (Asymmetric Digital Subscriber Line) line; or wireless, such as infrared radiation (IrDA, remote control), Bluetooth®, 802.11 wireless, HDR, mobile telephone network, satellite line, or terrestrial digital network. The present invention can be also realized by the program code in the form of a computer data signal embedded in a carrier wave which is embodied by electronic transmission.

The embodiment and concrete examples of implementation discussed in the foregoing detailed explanation serve solely to illustrate the technical details of the present invention, which should not be narrowly interpreted within the limits of such an embodiment and concrete examples, but rather may be applied in many variations within the spirit of the present invention, provided such variations do not exceed the scope of the patent claims set forth below.

### INDUSTRIAL APPLICABILITY

The present invention is widely usable as a display apparatus having a display panel which includes optical sensors. For example, the present invention can be realized as a liquid crystal display apparatus or an organic EL display apparatus.

### REFERENCE SIGNS LIST

1 Pixel circuit
2 Optical sensor
10 Display apparatus
11 Liquid crystal panel with built-in sensors (display panel)
12 Display data processing section
13 Display data outputting section
14 Illuminance detector section
15 Illuminance distribution calculating section
16 Panel drive circuit
17 Pixel array
18 Gamma characteristic calculating section
19 Display luminance correcting section
21 TFT
22 Liquid crystal capacitor
23 Capacitor
24 Photodiode
25 Sensor preamplifier
31 Scanning signal line drive circuit
32 Data signal line drive circuit
33 Sensor row drive circuit
34 Sensor output amplifier
35, 36, 37, and 38 Switch
40 to 43, 70, 71, 90, 91, 110 to 112, 131, 132, 151, 152, 171, and 172 Display area
50, 51, 53, 80, 81, 83, 100, 101, 103, 105, 120 to 122, 124, 126, 128, 140, 141, 143, 160, 161, 163, 180, 181, and 183 Characteristic
52, 82, 102, 104, 123, 125, 127, 142, 162, and 182 Arrow
61 Glass substrate
62 Color filter
63 Liquid crystal
65 Light blocking section
66 TFT layer
67 Backlight layer
130 and 150 Priority area
170 Organic EL panel (display panel)

1. A display apparatus comprising:
a display panel including optical sensors;
an illuminance detector section for measuring, on the basis of an output from an optical sensor, an illuminance in a display area corresponding to the optical sensor; and
a display luminance correcting section for correcting, on the basis of illuminances measured by the illuminance detector section, a display luminance in at least one of the display areas.

2. The display apparatus as set forth in claim 1, further comprising a backlight for irradiating the display panel with light,
the display luminance correcting section correcting an aperture ratio with respect to the light in the at least one of the display areas so as to correct the display luminance in the at least one of the display areas.

3. The display apparatus as set forth in claim 2, wherein the display panel is a liquid crystal panel.

4. The display apparatus as set forth in claim 1, wherein:
the display panel includes a plurality of self-luminous display elements; and
the display luminance correcting section corrects an emission intensity of at least one of the plurality of self-luminous display elements in the at least one of the display areas so as to correct the display luminance in the at least one of the display areas.

5. The display apparatus as set forth in claim 4, wherein the display panel is an organic EL panel or a plasma panel.

6. The display apparatus as set forth in claim 1, further comprising:
an illuminance distribution calculating section for calculating, on the basis of the illuminances measured by the illuminance detector section, an illuminance distribution on the display panel; and
a gamma characteristic calculating section for calculating respective gamma characteristics of the display areas, the gamma characteristic calculating section specifying the display areas on the basis of the illuminance distribution calculated by the illuminance distribution calculating section,
the display luminance correcting section correcting the display luminance in the at least one of the display areas on the basis of the gamma characteristics calculated by the gamma characteristic calculating section.

7. The display apparatus as set forth in claim 6, wherein the display luminance correcting section corrects the display luminance on the basis of sizes of the specified display areas with respect to a size of whole of the display panel.

8. The display apparatus as set forth in claim 6, wherein:
a priority area is provided within the display panel in advance in which priority area a higher viewability is secured on a priority basis;
the specified display areas are areas within the priority area; and
the display luminance correcting section corrects the display luminance on the basis of sizes of the specified display areas with respect to a size of the priority area.

9. The display apparatus as set forth in claim 7, wherein the display luminance correcting section approximates a display luminance of one of the specified display areas which has a lower illuminance to a display luminance of another of the specified display areas which has a higher illuminance.

10. The display apparatus as set forth in claim 7, wherein the display luminance correcting section approximates a display luminance of one of the specified display areas which has a higher illuminance to a display luminance of another of the specified display areas which has a lower illuminance.

11. The display apparatus as set forth in claim 7, wherein the display luminance correcting section approximates, to each other, a display luminance of one of the specified display areas which has a higher illuminance and a display luminance of another of the specified display areas which has a lower illuminance.

12. The display apparatus as set forth in claim 1, wherein the optical sensors are provided pixel by pixel.

13. The display apparatus as set forth in claim 1, wherein each of the optical sensors is provided so as to correspond to a plurality of pixels.

14. A display method which is performed by a display apparatus having a display panel which includes optical sensors, the display method comprising the steps of:
measuring, on the basis of an output from an optical sensor, an illuminance in a display area corresponding to the optical sensor; and
correcting, on the basis of the illuminances measured in the step of measuring, a display luminance in at least one of the display areas.

15. A program causing a display apparatus recited in claim 1 to operate, the program causing a computer to serve as the sections of the display apparatus.

16. A computer-readable storage medium storing a program recited in claim 15.
